(19) United States
(12) Patent Application Publication
(10) Pub. No.: US 2014/0199467 A1
(43) Pub. Date: Jul. 17, 2014

(54) LIQUID FEED COMPRISED OF CORN STEEPWATER AND HYDROL

(71) Applicants: Laura M. Packwood, Bedford Park, IL (US); Brian M. Kueber, Bedford Park, IL (US)

(72) Inventors: Laura M. Packwood, Bedford Park, IL (US); Brian M. Kueber, Bedford Park, IL (US)

(73) Assignee: CORN PRODUCTS DEVELOPMENT, INC., Bridgewater, NJ (US)

(21) Appl. No.: 13/739,203

(22) Filed: Jan. 11, 2013

(51) Int. Cl. A23K 1/14

(52) U.S. Cl. CPC A23K 1/146
USPC 426/656

(57) ABSTRACT

The application relates to a composition comprising: from about 10 parts to about 40 parts of hydrol and from about 60 parts to about 90 parts of steepwater by volume.

### INTRODUCTION

Liquid feed supplements for animals have been used for many years in the United States. These are often made by combining a protein (nitrogen) source and a carbohydrate source. An economical protein source for liquid feed is the agricultural processing by-product corn steepwater. An economical carbohydrate source for liquid feed is the agricultural processing by-product hydrol. Both are prone to partial crystallization or phase separation, particularly during cold weather. These are typically shipped separately to the farmer and mixed immediately prior to use.

Corn steepwater is a byproduct of the initial stages of wet milling of corn. In conventional wet milling, corn is steeped, i.e. soaked in 0.1-0.3% aqueous sulfur dioxide solution, at 48-55° C. for 28 to 72 hours. In water, the sodium dioxide form sulfurous acid, which controls fermentation and softens the corn kernel. Steeping of corn aids in the separation the various components of corn such as starch and nutrients. The softened corn is then separated into germ, gluten, fiber, starch, and light steepwater. The light steepwater contains between 6-9% solids by weight. The light steepwater is then evaporated until it contains 40-60% solids to form heavy corn steepwater or corn steep liquor.

Approximately 5-9 gallons of water per bushel of corn is added during the process. Approximately one-third of the water is absorbed by the corn during the steeping, and the other two-thirds is present as light steepwater. Steepwater provides a relatively inexpensive starting material that includes a number of nutrients that are utilized as an ingredient in animal feed and for fermentation applications. The primary use of corn steep liquor is as a nutrient for ruminant animals. Corn steep liquor provides proteins, amino acids, minerals, vitamins, reducing sugars (such as dextrose), organic acids (in particular lactic acid), enzymes, and elemental nutrients such as nitrogen. The majority of corn steep liquor produced is immediately added to corn gluten and fibrous materials for use as animal feed.

Corn steep liquor is also used by the pharmaceuticals industry in the production of antibiotics. In 1941 Dr. Andrew Moyer at the Northern Regional Laboratory of the USDA discovered by that replacing the usual artificial medium used to grow the penicillin mold by corn steepwater and lactose increased the yield of penicillin from two units per mL, which was too small to be commercially practicable, to one hundred units per mL.

Legg in UK Patent No. 249,833 issued May 19, 1927 teaches a composition comprising, “hydrol 5-8% ‘concentrated steepwater’ 0.5-3.0%” used as fermentation medium for making butyl alcohol and acetone. Kelling in U.S. Pat. No. 2,192,611, issued Mar. 5, 1940 describes a cattle feed comprising, “one part of hydrol at 30° to 42° Baumé . . . one part, dry substance basis, of steepwater, at the concentration of the steepwater as it comes from the evaporators”. Moyer in U.S. Pat. No. 2,443,989, issued Jun. 22, 1948 teaches three compositions comprising, “corn-steeping liquor-100 ml lactose-66.0 g”, “20.0 g. of lactose . . . and 40 ml of concentrated coin-steeping liquor (30° Baumé”, and “40 ml of concentrated corn-steeping liquor, and sufficient water added to make one liter. To 100 nil aliquots in 300 ml. Erlenmeyer flasks, 2.0 g. of lactose, glucose, sucrose, sorbitol or glycerin” used as a fermentation medium for making penicillin. Kail in U.S. Pat. No. 3,523,798, issued Aug. 11, 1970 teaches a “liquid supplement for dairy cattle”, comprising, “cane molasses (65% solids) 30.00 distiller's solubles (35% solids) 35.00”. Grosso et al. in U.S. Pat. No. 3,962,484, issued Jun. 8, 1976, teach a composition comprising, “cane molasses 32.5 grain fermentation solubles 6.0” in “a liquid animal feed supplement”. Ethington et al. in Patent Application Publication No. US 2003/0152689 A1, dated Aug. 14, 2003, teach two compositions comprising, “1640 corn syrup 21.41% heavy steepwater 75.50%” and “1640 corn syrup 10.69% heavy steepwater 86.19%” used to make an, “amorphous solid cast feed product”.

### SUMMARY

In one aspect, the application provides a composition comprising: from about 10 parts to about 40 parts of hydrol and from about 60 parts to about 90 parts of steepwater by volume.

### DETAILED DESCRIPTION

In one aspect, the application provides a composition comprising: from about 10 parts to about 40 parts of hydrol and from about 60 parts to about 90 parts of steepwater by volume.

In one aspect, the application provides a composition consisting essentially of: from about 10 parts to about 40 parts of hydrol and from about 60 parts to about 90 parts of steepwater by volume.

In one aspect, the application provides a composition consisting of: from about 10 parts to about 40 parts of hydrol and from about 60 parts to about 90 parts of steepwater by volume.

In one embodiment, the amount by volume of hydrol is from about 10 parts to about 35 parts and the amount of steepwater is from about 75 parts to about 90 parts.

In one embodiment, the amount by volume of hydrol is from about 10 parts to about 30 parts and the amount of steepwater is from about 70 parts to about 90 parts.

In one embodiment, the amount by volume of hydrol is from about 20 parts to about 35 parts and the amount of steepwater is from about 75 parts to about 80 parts.

In one embodiment, the amount by volume of hydrol is from about 20 parts to about 30 parts and the amount of steepwater is from about 70 parts to about 80 parts.

In one embodiment, the amount by volume of hydrol is about 30 parts and the amount of steepwater is about 70 parts.

In one embodiment, the steepwater is heavy steepwater.

In one aspect, the application provides a process comprising mixing together: from about 10 parts to about 40 parts of hydrol and from about 60 parts to about 90 parts of steepwater by volume.

In one embodiment, the application provides a process comprising mixing together: from about 10 parts to about 30 parts of hydrol and from about 70 parts to about 90 parts of steepwater by volume.

In one aspect, the application provides animal feed comprising: from about 10 parts to about 40 parts of hydrol and from about 60% to about 90% of steepwater by volume.

In one embodiment, the application provides animal feed comprising: from about 10 parts to about 30 parts of hydrol and from about 70 parts to about 90 parts of steepwater by volume.

Although both hydrol and heavy steepwater are aqueous, they can form separate phases as shown below. Both materials are polydisperse systems, i.e. the colloidal particles are not precisely identical to each other, but have a range of radii, surface charges, shapes, etc). They consist of a large number of different molecular species best described as having continuously varying properties across each family of molecules. All these materials are therefore polydisperse. Hydrol and heavy steepwater contain particles with properties depending continuously on one or several parameters. It is not possible to predict the number of phases in such systems because the Gibbs phase rule allows for an infinite number of phases in polydisperse systems. Nor is it possible to predict the conditions where phase separation will occur. As stated by Peter Sollich in “Predicting Phase Equilibria in Polydisperse Systems”, J. Phys.: Condens. Matter 14 (2002) R79-R117, “the challenge in predicting polydisperse phase equilibria arises from the effectively infinite number of conserved densities. This renders the standard approaches developed for mixtures with a finite number of species useless.”

### DEFINITIONS

The following definitions are used in connection with the compounds of the present application unless the context indicates otherwise. As used herein, the term, “corn steep liquor” means the brownish material with a pudding like consistency made by the concentration of light steepwater. “Corn steep liquor” typically ranges from about 45% to about 55% dry matter with an average of 53% dry matter. With the partial fermentation that occurs in the steeping process, lactic acid is produced which lowers the pH of “corn steep liquor” to a value from about 3.8 to about 4.1. Typical “corn steep liquor” has a dry solid content of about 48% and a density of 10.25 lb/gallon. The non-aqueous material in “corn steep liquor” include about 44% protein, 35% nitrogen-free extract, 23% lactic acid, 19% inorganic material, 10% sugars, and a variety of amino acids

As used herein, the term “dextrose” means the simple sugar glucose. As used herein, the term “dextrine” means any one, or the mixture, of the water-soluble, intermediate polysaccharides formed during the hydrolysis of starch to sugar.

As used herein, the term “hydrol” means the mother liquor or residual corn syrup from the purification, usually by crystallization or chromatographic separation, of dextrose obtained in the production of glucose by the hydrolysis of starch. Hydrol syrup has the following approximate composition: dextrose 60%, dextrine 20%, and water 20%. A typical density of hydrol is 11.25 lb/gal.

As used herein, the term, “steepwater” includes all varieties of water that are removed from the corn after steeping. For example, one variety of steepwater is “light steepwater” which contains the soluble materials (including protein, amino acids, sugars, and phytate) originating from the corn kernel and fermentation products (mainly lactic acid and ethanol) produced from the fermentation of corn solubles during steeping. Typical light steepwater has a dry solid content of about 8-12%. Another variety of steep-water is “heavy steepwater” or “corn steep liquor”.

Certain specific aspects and embodiments of the present application will be explained in greater detail with reference to the following examples, which are provided only for purposes of illustration and should not be construed as limiting the scope of the application in any manner. Reasonable variations of the described procedures are intended to be within the scope of the present invention. While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Examples

Samples of hydrol and steepwater were mixed in the volume ratios given in Table 1 to make samples of approximately 100-400 mL total volume. The samples were mixed at room temperature for one hour using a shaker-type mixer. One hour after the mixing ended, any phase separation was noted.

TABLE 1

| | | | calculated | calculated | calculated | calculated |
|---|---|---|---|---|---|---|
| | | 1 hour after | steepwater/hydrol | steepwater/hydrol | steepwater | hydrol |
| hydrol | steepwater | mixing then settled | volume ratio | mass ratio | % by mass | % by mass |
| 90 | 10 | steepwater sits on | 0.11 | 0.10 | 0.09 | 0.91 |
| | | top of hydrol | | | | |
| 80 | 20 | steepwater sits on | 0.25 | 0.22 | 0.18 | 0.82 |
| | | top of hydrol | | | | |
| 70 | 30 | slight mix, | 0.43 | 0.38 | 0.27 | 0.73 |
| | | steepwater more | | | | |
| | | on top | | | | |
| 60 | 40 | slight mix, | 0.67 | 0.59 | 0.37 | 0.63 |
| | | steepwater more | | | | |
| | | on top | | | | |
| 50 | 50 | mixed, thin layer | 1.00 | 0.88 | 0.47 | 0.53 |
| | | of hydrol on top | | | | |
| 40 | 60 | mixed, thin layer | 1.50 | 1.32 | 0.57 | 0.43 |
| | | of hydrol on top | | | | |
| 30 | 70 | mixed | 2.33 | 2.06 | 0.67 | 0.33 |
| 20 | 80 | mixed | 4.00 | 3.52 | 0.78 | 0.22 |
| 10 | 90 | mixed | 9.00 | 7.93 | 0.89 | 0.11 |

The pH and the percentage of dry substance (DS) in each batch were also measured at this time using an Accumet AR15 pH probe and an ISMA-M55 HB43 Halogen moisture analyzer, respectively. The dry substance measurement was done at 90° C. The results are given in Table 2.

TABLE 2

| hydrol | steepwater | % DS | pH |
|---|---|---|---|
| 100 | 0 | 84.8 | 2.95 |
| 90 | 10 | 79.4 | 3.70 |
| 80 | 20 | 77.0 | 3.70 |
| 70 | 30 | 70.0 | 3.68 |
| 60 | 40 | 73.8 | 3.79 |
| 50 | 50 | 67.5 | 3.86 |
| 40 | 60 | 64.2 | 3.78 |
| 30 | 70 | 59.5 | 3.95 |
| 20 | 80 | 57.6 | 4.02 |
| 10 | 90 | 52.7 | 4.05 |
| 0 | 100 | 50.8 | 4.10 |

Twenty four hours after the completion of stirring, the amount of dry substance in samples of selected batches was determined as above. The results are shown in Table 3. As can be seen, in the homogeneous sample there was a slight decrease in the measured dry substance, while in the two nonhomogeneous samples there was a slight increase.

TABLE 3

| hydrol | steepwater | sample volume | % DS |
|---|---|---|---|
| 70 | 30 | 400 mL | 72.0 |
| 70 | 30 | 100 mL | 72.7 |
| 50 | 50 | 100 mL | 67.3 |
| 30 | 70 | 400 mL | 58.8 |
| 30 | 70 | 100 mL | 59.3 |

Four days after the completion of the stirring, the amount of dry substance in two of the batches was measured again. The results are shown in Table 4. This time, there was a slight decrease in the total dry substance in the inhomogeneous sample while the homogenous sample was unchanged.

TABLE 4

| hydrol | steepwater | sample volume | % DS |
|---|---|---|---|
| 70 | 30 | 400 mL | 71.6 |
| 30 | 70 | 400 mL | 58.8 |

Six days after the completion of stirring, the amount of dry substance in samples of seven batches was determined as above. The results are shown in Table 5. As can be seen, in both the homogeneous samples and inhomogeneous sample there was a decrease in the total dry substance.

TABLE 5

| hydrol | steepwater | % DS | % DS after 1 hour |
|---|---|---|---|
| 80 | 20 | 75.0 | 77.0 |
| 70 | 30 | 71.0 | 70.0 |
| 60 | 40 | 66.4 | 73.8 |
| 50 | 50 | 62.0 | 67.5 |
| 40 | 60 | 58.7 | 64.2 |
| 30 | 70 | 53.7 | 59.5 |
| 20 | 80 | 50.3 | 57.6 |
| 0 | 100 | 45.3 | 50.8 |

Pure cane sugar, 1142 corn syrup, high fructose corn syrup 55, 1652 corn syrup, and molasses were blended in various ratios with steepwater and observations were made with respect to subsequent phase separation. Some variation was present in the amount of dissolved solids (% DS) in the steepwater and is captured for reference in Table 6. Typical specifications are included in Table 7 for the syrup products used for blending. These were compared to the unique behavior of the hydrol/steepwater blend.

TABLE 6
blend data

| | sample/steepwater | steepwater | |
|---|---|---|---|
| sample/steepwater | ratio | % ds | mixture % ds |
| 1142 corn syrup/steepwater | 40/60 | 47.4 | 63.6 |
| high fructose corn syrup 55/ | 40/60 | 47.4 | 56.6 |
| steepwater | | | |
| cane sugar/steepwater | 40/60 | 46.7 | 66.6 |
| 1652 corn syrup/steepwater | 40/60 | 46.7 | 56.2 |
| molasses/steepwater | 40/60 | 54.9 | 64.8 |
| corn syrup/steepwater | 60/40 | 47.0 | 74.2 |
| fructose/steepwater | 60/40 | 49.3 | 62.3 |
| pure sugar/steepwater | 60/40 | 48.8 | 70.5 |
| 1652/steepwater | 60/40 | 49.3 | 86.2 |
| molasses/steepwater | 60/40 | 54.9 | 68.9 |
| corn syrup/steepwater | 20/80 | 49.3 | 57.6 |
| fructose/steepwater | 20/80 | 48.0 | 57.6 |
| pure sugar/steepwater | 20/80 | 48.8 | 57.1 |
| 1652/steepwater | 20/80 | 49.2 | 62.4 |
| molasses/steepwater | 20/80 | 53.2 | 57.7 |

TABLE 7
typical syrup product specifications

| | % | % | % | % | % | % |
|---|---|---|---|---|---|---|
| product | DS | dextrose | fructose | DP2 | DP3 | DP4+ |
| 1652 corn syrup | 81-82.7 | 35 | 0 | 30 | 13 | 22 |
| 1142 corn syrup | 79.7-81.5 | 20 | 0 | 13 | 12 | 55 |
| high fructose corn | 76.8-77.4 | 40 | 55 | 5 | 0 | 0 |
| syrup 55 | | | | | | |
| hydrol | 80.5-81.5 | 55 | 0 | 45 | 0 | 0 |

The following observations were made.

With pure sugar and steepwater:
30/70, the steepwater mixture turned to a tar substance that slugged instead of poured
40/60, same as the 30/70 mixture, sugar crystals sat on top of the mixture
60/40, the sugar took over the steepwater and began to chunk as is sat over a period of almost two weeks
20/80, the steepwater over took the sugar, but the sugar created a crystal layer on top of the steepwater.
With high fructose corn syrup and steepwater:
30/70, the fructose did not mix at all with the steepwater, it created a layer on top of the steepwater a day after settling
40/60, same as the 30/70, turned into a tar substance with a layer on top
60/40, still a large separation area between the steepwater and the fructose
20/80, even with a small amount of fructose used; there is still a layer of fructose settled on top of the steepwater.
With molasses/steepwater; all of the samples smelled very sweet from the molasses:
30/70, the molasses mixed with the steepwater but then created a thick sludge and smelled very sweet
40/60, not as thick as the 30/70 mixture, actually poured from the cup a lot smoother
60/40, not as thick as the 30/70 but it started to ferment after sitting for a week
20/80, started to ferment, possibly the steepwater was to blame for this sample
With 1652 corn syrup and steepwater:
30/70, sample mixed well, had a small thin layer of oil on top after settling for a week.
The sample smelled sweet, but not as strong as the molasses sample
40/60, same as the 30/70 mixture
60/40, the 1652 corn syrup settled at the bottom of the sample cup. The steepwater sat on top and began to ferment
20/80, steepwater overtook the 1652 corn syrup and created an oil layer after settling for over a week.
With 1142 corn syrup and steepwater:
30/70, the sample mixed, but had a fermented smell to it. An oil layer was also created on the top of the steepwater
40/60, the sample mixed the same as a 30/70 mixture. Still had a ferment smell and oil layer on top of the sample
60/40, the sample gelatinized and made a hard block in the center of the sample
20/80, all of the corn syrup added sat on top of the steepwater sample.

TABLE 8
mass vs. volume for 70% steepwater

| sample/steepwater | mass % DS | volume % DS |
|---|---|---|
| 1142 corn syrup/steepwater | 55.3 | 55.1 |
| high fructose corn syrup 55/ | 55.2 | 52.2 |
| steepwater | | |
| cane sugar/steepwater | 61.9 | 66.4 |
| 1652 corn syrup/steepwater | 57.4 | 61.2 |
| molasses/steepwater | 69.1 | 62.8 |

Additionally, two samples were held in refrigeration for 4 months; one sample was comprised of 70% steepwater and 30% hydrol, and the other was comprised of 70% steepwater and 30% molasses to replicate a typical commercial liquid feed supplement. After 4 months, the 70% steepwater and 30% hydrol blend showed some phase separation and some crystallization near the bottom of the sample jar, but remained fluid. The competitor replica showed substantial phase separation and crystallization, and was not fluid enough to pour.

Throughout this application, various publications are referenced. The disclosures of these publications in their entireties are hereby incorporated by reference into this application in order to more fully describe the state of the art as known to those skilled therein as of the date of the application described and claimed herein.

While particular embodiments of the present application have been illustrated and described, it would be obvious to those skilled in the art that various other changes and modifications can be made without departing from the spirit and scope of the application. It is therefore intended to cover in the appended claims all such changes and modifications that are within the scope of this application.

What is claimed is:

1. A composition comprising: from about 10 parts to about 40 parts of hydrol and from about 60 parts to about 90 parts of steepwater by volume.

2. The composition of claim 1, consisting essentially of: from about 10 parts to about 40 parts of hydrol and from about 60 parts to about 90 parts of steepwater by volume.

3. The composition of claim 2, consisting of: from about 10 parts to about 40 parts of hydrol and from about 60 parts to about 90 parts of steepwater by volume.

4. The composition of claim 1, wherein the amount by volume of hydrol is from about 10 parts to about 35 parts and the amount of steepwater is from about 75 parts to about 90 parts.

5. The composition of claim 1, wherein the amount by volume of hydrol is from about 10 parts to about 30 parts and the amount of steepwater is from about 70 parts to about 90 parts.

6. The composition of claim 4, wherein the amount by volume of hydrol is from about 20 parts to about 35 parts and the amount of steepwater is from about 75 parts to about 80 parts.

7. The composition of claim 5, wherein the amount by volume of hydrol is from about 20 parts to about 30 parts and the amount of steepwater is from about 70 parts to about 80 parts.

8. The composition of claim 7, wherein the amount by volume of hydrol is about 30 parts and the amount of steepwater is about 70 parts.

9. The composition of claim 1, wherein the steepwater is heavy steepwater.

10. A process comprising mixing together: from about 10 parts to about 40 parts of hydrol and from about 60 parts to about 90 parts of steepwater by volume.

11. The process of claim 10, comprising mixing together: from about 10 parts to about 30 parts of hydrol and from about 70 parts to about 90 parts of steepwater by volume.

11. An animal feed comprising: from about 10 parts to about 40 parts of hydrol and from about 60% to about 90% of steepwater by volume.

12. The animal feed of claim 12, comprising: from about 10 parts to about 30 parts of hydrol and from about 70 parts to about 90 parts of steepwater by volume.
